(19) United States
(12) Patent Application Publication
(10) Pub. No.: US 2002/0107049 A1
(43) Pub. Date: Aug. 8, 2002

(54) Audible caller identification for mobile communication device

(76) Inventors: Fanny Maquaire, Cagnes sur Mer (FR); Laurent Le-Faucheur, Saint Laurent-du-var (FR)

Correspondence Address: TEXAS INSTRUMENTS INCORPORATED, P O BOX 655474, M/S 3999, DALLAS, TX, 75265

(21) Appl. No.: 09/779,210

(22) Filed: Feb. 8, 2001

(51) Int. Cl. H04B 1/38

(52) U.S. Cl. 455/563; 455/564

(57) ABSTRACT

A mobile communications device (10) stores a database of telephone numbers (40), with one or more of the telephone numbers associated with respective audio files in an audio file database (44) and voice templates in a voice template database (42). Processing circuitry (30) implements voice activated dialing where one of the telephone numbers in the telephone number database (40) is dialed in response to identifying a match between an audio input from a user and one of templates in the voice template database (42). An audio file from the audio file database is played in response to a match. The processing circuitry (30) further detects originating telephone number associated with incoming telephone calls and, if the originating telephone number is associated with an audio file, plays the associated audio file from the same audio file database used for the voice activated dialing.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to telecommunications and, more particularly, to caller identification for mobile communications devices.

2. Description of the Related Art

For many years, the communications industry has improved the functionality of the telephone system. New services, such as Caller ID, Call Waiting, and Voice Activated Dialing are examples of functions that have been added to the phone system to improve the quality of communications. In addition to new functionality, mobile communication devices have evolved to provide communication resources apart from a wireline connection.

Because of the cost of wireless communications, many users desire to screen calls, i.e., they only answer calls from certain people. Most mobile communications systems provide Caller ID functions to mobile phones to aid with screening. With Caller ID, the name of the calling party is presented on the phone's display. This requires the user to look at the phones display to identify the caller. This can be very inconvenient if the phone is not located in the immediate vicinity of the called party. If the called party is operating a vehicle when the call arrives, viewing the phone's display can be dangerous.

To reduce this risk, some mobile phones provide a distinctive ring that can be associated with groups of telephone numbers. For example, a first ring type could be associated with number of co-workers, a second ring type could be associated with family members, and a third ring type could be associated with clients. However, it is not practical to provide different ring types for each caller, because it would be impossible to remember the associations for more than a few people.

Accordingly, a need exists for a more efficient method and apparatus for identifying callers using a mobile communications device.

### BRIEF SUMMARY OF THE INVENTON

The present invention provides a mobile communications device comprising a database of telephone numbers, with one or more of the telephone numbers associated with respective audio files and voice templates. Voice activated dialing circuitry dials one of the telephone numbers in response to identifying a match between an audio input from a user and one of templates, and plays the associated audio file in response to the match. Caller identification circuitry detects an originating telephone number associated with an incoming telephone call and, if the originating telephone number is associated with an audio file, playing the associated audio file.

The present invention provides significant advantages over the prior art. First, it allows for an audible indication of the calling party for the most frequently used numbers. Second, the capability for audible indication, in the user's own voice, can be accomplished without additional memory, since the audio files are shared with the voice activated dialing function. Accordingly, the additional power and cost associated with the audible caller identification function is minimal.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a perspective view of a mobile communications device;

FIG. 2 illustrate a block diagram of the mobile communications device of FIG. 1 with audible caller identification circuitry;

FIG. 3 illustrates a functional block diagram of the operation of FIG. 2 with respect to audible caller identification and voice activated dialing; and

FIG. 4 illustrates a flow diagram illustrating the operation of an audible caller identification task.

### DETAILED DESCRIPTION OF THE INVENTION

The present invention is best understood in relation to FIGS. 1-4 of the drawings, like numerals being used for like elements of the various drawings.

FIG. 1 illustrates a mobile communication device for providing wireless communications. The mobile communication device 10 of FIG. 1 could be, for example, a cellular phone, smart phone, satellite phone, portable computer or a PDA (personal digital assistant) with wireless communications capabilities. The overall look of the device 10 could vary according to its capabilities; however, most mobile communication devices will have similar attributes: a display 12, an input keypad 14 (which may be integrated with the display 12 using a touch screen), a microphone 16, a conversation speaker 18 (for audio when pressed to the user's ear), a loudspeaker/ringer 20, and an antenna 22.

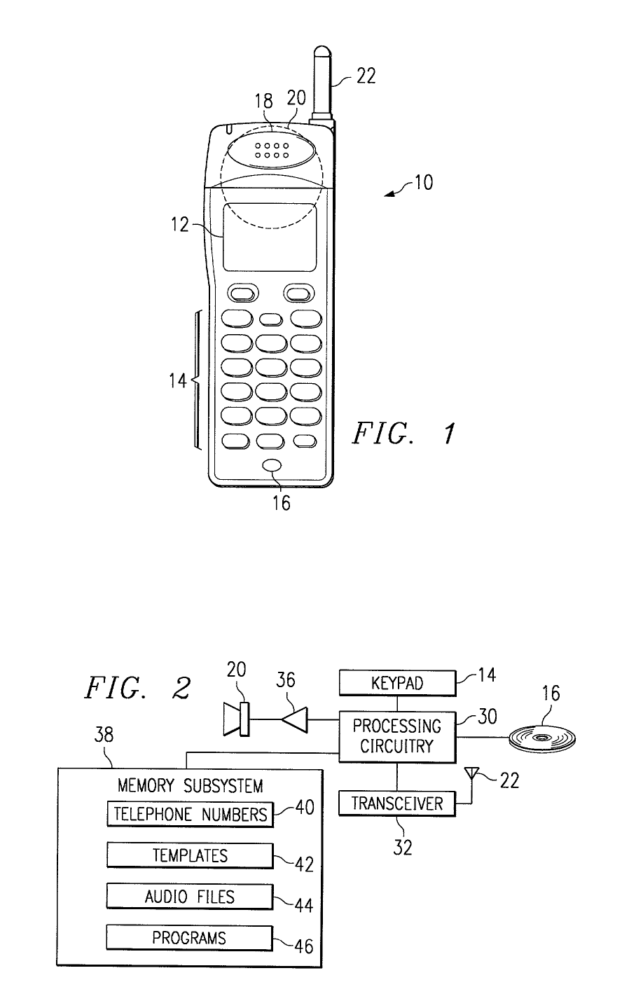

In operation, the mobile communications device 10 has both voice activated dialing capabilities and audible caller identification capabilities. For the voice activated dialing, the internal circuitry of the mobile communications device 10 stores information used for voice activated dialing in a memory subsystem (see FIG. 2). The information stored by the mobile communications device 10 includes a telephone number database (storing a plurality of frequently called numbers), a voice template database (storing voice templates used to recognize an utterance by the user indicative of a particular telephone number), and an audio file database (for confirmation of a voice dialed number), typically in the users own voice).

When a user creates a new entry for the voice activated dialing system, he or she speaks the designation for the new number (such as “John”, “work”, or “home”) and enters the number, either by speaker independent voice recognition, or by using the telephone keypad. The spoken designation is stored as an audio file (such as a *.wav file) and a template is made from the audio file; this template is used later for speech recognition. For each voice activated dialing entry, the telephone number, template and audio file are linked.

The user may call any entry on the voice dialing list by speaking “Call” (or another suitable command) and the designation. Accordingly, “call home” would result in the telephone number associated with “home” being dialed. To identify the desired telephone number, the voice dialing circuitry parses the utterance (i.e., separates “call” and “home”) and compares the stored templates with the designation portion of the utterance (i.e., “home”). Using techniques well known in the art, the designation portion of the utterance is matched to one of the templates, typically by assigning a score to each comparison. If the comparison with the best score meets a certain threshold, a match occurs, and the phone number and audio file associated with the matching template are retrieved. Prior to dialing, however, the audio file associated with the matching template is played to the user as a confirmation. Thus, if the user voice dials using “call John” and the mobile communications device 10 responds with “calling Jean” (where “Jean” is the audio file associated with the errantly matched template), the user can cancel the phone call before the connection is made. The voice dialing database could be used for other commands as well, such as “page John”, depending upon the capabilities of the mobile communications device 10.

The present invention uses the same audio files created for voice activated dialing for caller identification. On an incoming call, the mobile communications device 10 receives data indicating the originating telephone number. This information is compared to the telephone numbers stored in the voice activated dialing database. If there is a match, the audio file associated with that number is retrieved and played. Accordingly, the user receives an audible indication of the calling party prior to answering the phone.

FIG. 2 illustrates a basic block diagram showing the circuitry used in the voice activated dialing and the audible caller identification functions. Processing circuitry (typically, a digital signal processor, generally referred to as a “DSP” or a multiple microprocessor/DSP system) 30 is coupled to a transceiver 32, memory subsystem 38, keypad 14, microphone 16, and audio output circuitry 36. Output circuitry 36 is coupled to speaker 20. Antenna 22 is coupled to transceiver 32. Memory subsystem 38 includes locations for telephone numbers 40, templates 42, audio files 44 and programs 46. It should be noted that other data would also be stored in memory subsystem 38.

Memory subsystem 38 may include memory internal to processing circuitry 30, external to processing circuitry 30, or a combination of internal and external memory. Processing circuitry 30 may receive data and commands through keypad 14, microphone 16 (using speaker dependent and/or speaker independent voice recognition), and from telecommunications signals via transceiver 32.

During operation of the mobile communications device 10, the processing circuitry will execute a number of tasks. For example, the processing circuitry will be monitoring inputs from the keypad 14, microphone 16 and transceiver 32. If, for example, a number is dialed using the keypad, the processing circuitry will accumulate numbers from the keypad 14, and initiate a connection via one or more base stations. Similarly, a voice input via the microphone would be monitored via a speech recognition task to determine whether a command, such as “call”, was being issued. If so, the designated party would be determined using speech recognition, and the telephone number would be retrieved from memory subsystem 38 using a voice activated dialing task.

Processing circuitry 30 also monitors transceiver 32 for incoming calls directed to the mobile communications device 10. When such a call is received, the originating number is received using typical caller identification techniques. The originating number is compared to numbers in the telephone number database 40. If there is a match, the associated audio file is played through speaker 20 and the information is presented on display 12.

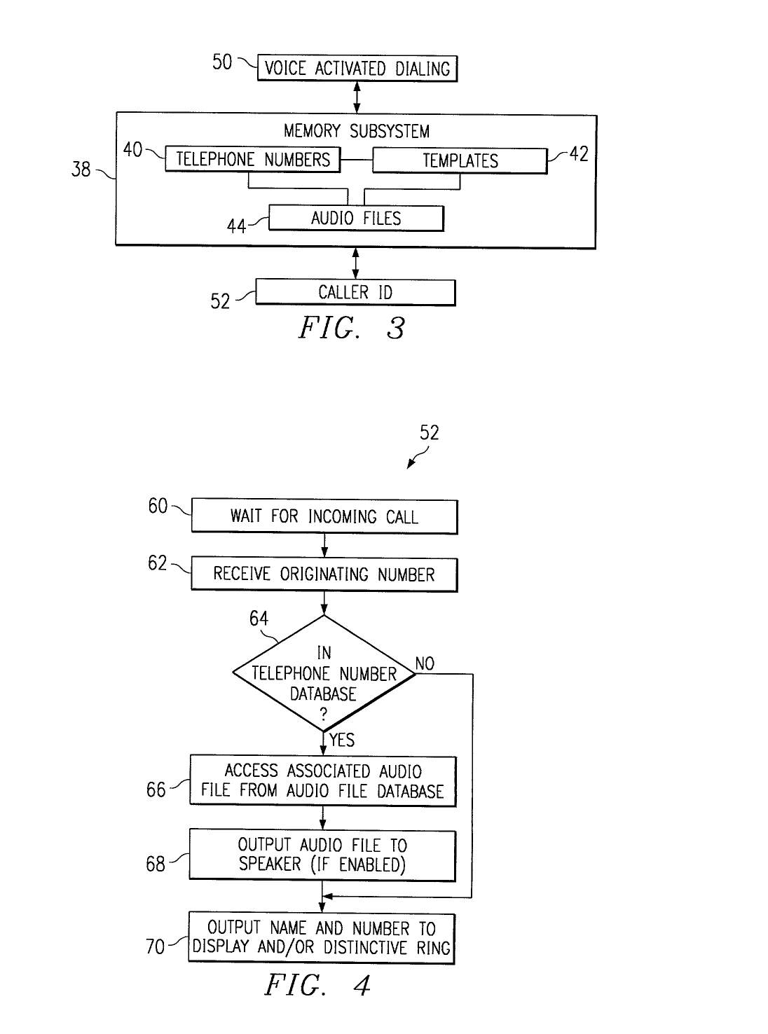

FIG. 3 illustrates a block diagram showing the interaction between the voice activated dialing task 50 and the audible caller identification task 52. Both the voice activated dialing task 50 and the caller identification task 52 access the audio files database 44 and the telephone numbers database 40.

FIG. 4 illustrates a block diagram of the audible caller identification task 52. In block 60, the task 52 waits for an incoming call directed to the mobile communications device 10. When an incoming call is received, the originating number is derived from the data stream in block 62. The originating number is compared to numbers in the telephone number database 40 used for voice activated dialing. If there is a match in decision block 64, the audio file associated with the matching telephone number is accessed from the audio file database 44. This audio file is played to the user in block 68, if the feature is enabled (in many circumstances, the user will not want the name to be audibly output, so the feature may be disabled by the user). In block 70, the name and number are visually displayed to the user.

In addition to playing the audio file from the audio file database, the processing circuitry 30 may also play an accompanying audio file, such as “you have a call from” or “is calling”. Accordingly, the complete audio output from the caller identification task could be “you have a call from home” or “john is calling.” The accompanying recording could synthesized speech or recorded by the user.

If, in decision block 64, the originating number is not found in the telephone database 40, then the name and number is output on the display 12 without playing the audio file. Additionally, or in the alternative, a distinctive ring could be played, where the distinctive ring indicates a group of one or more telephone number associated with the calling party.

The present invention provides significant advantages over the prior art. First, it allows for an audible indication of the calling party for the most frequently used numbers. Second, the capability for audible indication, in the user's own voice, can be accomplished without additional memory, since the audio files are shared with the voice activated dialing function. Accordingly, the additional power and cost associated with the audible caller identification function is minimal.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the claims.

1. A mobile communications device comprising:
a database of telephone numbers, one or more of the telephone numbers associated with respective audio files and voice templates;
voice activated dialing circuitry for dialing one of the telephone numbers in response to identifying a match between an audio input from a user and one of templates, and for playing the associated audio file in response to said match; and;
caller identification circuitry for detecting an originating telephone number associated with an incoming telephone call and, if said originating telephone number is associated with an audio file, playing the associated audio file.

2. The mobile communications device of claim 1 and further comprising a display for displaying name associated with a telephone caller.

3. The mobile communications device of claim 2 wherein the display further displays said originating telephone number.

4. The mobile communications device of claim 1 wherein said caller identification circuitry further plays a distinctive ring associated with said originating telephone number if the originating telephone number is not associated with an audio file.

5. The mobile communications device of claim 1 wherein said audio files are recordings of the user's voice.

6. The mobile communications device of claim 1 wherein said mobile communications device is a cellular telephone.

7. The mobile communications device of claim 1 wherein said mobile communications device is a smart phone.

8. The mobile communications device of claim 1 wherein said mobile communications device is a personal digital assistant.

9. The mobile communications device of claim 1 wherein said mobile communications device is a portable computer.

10. A method of interfacing with a mobile communications device, comprising the steps of:
storing frequently called numbers in a telephone number database, one or more of the telephone numbers in said telephone number database associated with respective audio files and voice templates;
receiving an audio input from a user for dialing one of said frequently dialed telephone numbers;
in response to receiving said audio input, identifying a match between said audio input and one of templates and playing the associated audio file in response to said match; and;
detecting an originating telephone number associated with an incoming telephone call and, if said originating telephone number is associated with an audio file, playing the associated audio file.

11. The method of claim 10 and further comprising the step of displaying name associated with a telephone caller.

12. The method of claim 11 and further comprising the step of displaying said originating telephone number.

13. The method of claim 10 and further comprising the step of playing a distinctive ring associated with said originating telephone number if the originating telephone number is not associated with an audio file.

14. The method of claim 10 wherein said audio files are recordings of the user's voice.

15. A mobile communications device comprising:
a database of telephone numbers, one or more of the telephone numbers associated with respective audio files and voice templates;
processing circuitry for executing a first task for performing voice activated dialing using said telephone numbers, audio files and voice templates and for executing a second task for performing caller identification playing one of said audio files in response to receiving a call from an originating telephone number associated with said one audio file.
